(19) United States
(12) Patent Application Publication
(10) Pub. No.: US 2017/0261449 A1
(43) Pub. Date: Sep. 14, 2017

(54) METHOD FOR DETERMINING THE NEUTRAL TEMPERATURE IN LONG-STRETCHED WORKPIECES

(71) Applicant: Goldschmidt Thermit GmbH, Leipzig (DE)

(72) Inventors: André Klepel, Authausen (DE); Andreas Peters, Leipzig (DE)

(21) Appl. No.: 15/452,160

(22) Filed: Mar. 7, 2017

(30) Foreign Application Priority Data
Mar. 8, 2016 (DE) 10 2016 002 692.8

(51) Int. Cl. G01N 25/02; G01B 17/04; G01B 7/24

(52) U.S. Cl. CPC G01N 25/02; G01B 7/24; G01B 17/04

(57) ABSTRACT

The invention pertains to a method for respectively determining the neutral temperature or the stressfree state in a rail section (1), wherein an ultrasonic signal is coupled into a representative volume of the rail profile perpendicular to its longitudinal direction, wherein the volume is subjected to stresses in the longitudinal direction of the rail section (1), wherein the stresses are measured, wherein an ultrasonic signal influenced by these stresses is decoupled, wherein a function describing the functional dependence of the decoupled ultrasonic signal on the introduced stress is determined, and wherein the stressfree state is determined based on the course of this function.

The invention pertains to a method according to the preamble of claim 1.

The neutral temperature of these workpieces—which may consist, for example, of rails, pipes or other rolled sections—describes a stressfree state, primarily with respect to thermally related stresses. Accordingly, compressive stresses occur when this temperature is exceeded and tensile stresses occur when this temperature is not reached. In the present description, the workpieces primarily consists of rails.

In this context, it is known to carry out invasive methods, in which a state of stress in the rail is determined based on a rail section with the aid of strain gauges. Although these methods are particularly reliable with respect to their results, they require a significant effort, particularly the closing of the corresponding rail line, and therefore do not represent the preferred solution.

Absolute measuring methods such as, for example, those based on an x-ray diffraction analysis require information on material parameters of the rail, e.g. the alloy-dependent lattice constants, which are frequently not readily available. In addition, only stresses in the surface area are detected in this way, wherein significant measurement uncertainties result from a superposition of load-induced stresses with potential internal stresses.

Relative measuring methods on the basis of strain gauges or even ultrasound always require a reference value and therefore a calibration on an identical stressfree rail section, which is frequently only possible during the new construction of rail lines. Consequently, the reliability of the measurement result is decisively influenced by uncertainties with respect to the suitability of the reference value used.

A calibration is no longer required in the methods known from publications US 2015 0377 836 A1 and US 2014 0316 719 A1, wherein an ultrasonic signal is introduced into the rail body to be checked for longitudinal stresses, wherein a response signal is evaluated, and wherein the neutral temperature is determined from the course of a parameter of the response signal in dependence on the rail temperature based on the course of this dependence. A disadvantage of these known methods can be seen in that the measurements have to be carried out over a more or less broad temperature range and are only successful if the neutral temperature lies within this temperature range. This can result in considerable measuring periods, which in turn leads to the additional problem that it is uncertain whether or not the state of the permanent way changes within these measuring periods. Furthermore, measurements with surface waves only detect states of stress on the rail surface such that a measurement result can be distorted due to internal stresses.

U.S. Pat. No. 5,386,727 discloses a non-invasive method for determining the local neutral temperature of a rail connection to be welded, wherein longitudinal stresses in a track are determined with the aid of a pulsed signal of an ultrasonic transmitter, which is received in modified form in accordance with the current longitudinal stresses of the track, wherein the neutral temperature is analytically determined based on this received signal, the respective rail temperature and the existing rail joints, particularly the gaps between the end faces of opposing rail ends.

WO 2005/004504 A1 discloses a method for welding together two rail ends of a track, in which the two rail ends, which are respectively gripped by a pair of clamping jaws of a welding machine, are moved in the longitudinal direction of the track and welded together, wherein mechanical stresses are introduced into the rail ends to be welded together in case of a deviation between the current rail temperature and a local neutral temperature and in accordance with this deviation, and wherein a compressive force is introduced into the end of one of the two rails facing away from the welding point by means of a rail pressing device in order to generate a compressive stress. This should make it possible to also produce a welded joint above a neutral temperature.

U.S. Pat. No. 5,009,097 discloses a welding unit that also makes it possible to produce a welded joint below a neutral temperature by introducing tensile forces into the rail ends to be welded together.

The disadvantages of these known methods can be seen in that they require a calibration, that they cannot be carried out nondestructively, that they require information on the material parameters of the rails being analyzed, that they require lengthy measuring periods and are therefore associated with the risk of temperature changes during the measurement or that they are distorted by internal stresses and therefore unusable.

The invention is based on the objective of simplifying a method of the initially cited type in comparison with the above-described prior art, particularly in such a way that it can be carried out without information on the material parameters, without calibration, without reference values, without being influenced by internal stresses, without being limited to surface areas, as well as in a comparatively short time period. In such a method, this objective is attained with the characteristic features disclosed in the characterizing portion of claim 1.

According to the invention, it is therefore essential to respectively evaluate a signal or signal sequence, which is influenced by the value of a longitudinal stress in the workpiece and has passed through a representative volume of the workpiece to be analyzed, which is subjected to defined longitudinal stresses, essentially transverse to its longitudinal direction, as well as to record a function that describes the dependence between a parameter of this signal and the longitudinal stress.

The aforementioned parameter is a parameter that is dependent on the longitudinal stress, wherein the stressfree state can be determined from the course of this function. Any parameter of the signal that changes in dependence on the longitudinal stress can basically be used for this purpose. A significant advantage in comparison with the initially described prior art can be seen in that only the longitudinal stress introduced into the workpiece has to be changed over a certain range, namely the range comprising the stressfree state, but not the temperature, which is only measured once. Consequently, the inventive method can be carried out within significantly shorter measuring periods because it actually is only based on the values of the longitudinal stress introduced into the workpiece and the values of the parameter of the decoupled signal to be analyzed. Prolonged measuring periods are therefore not required. The method eliminates the need for a calibration and reference values, wherein the measurement result is also not influenced by internal stresses in the workpiece. In addition, the method also eliminates the need for information on material parameters.

According to the characteristic features of claim 2, the aforementioned signal respectively consists of a magnetic signal or a magnetic signal sequence such that the method is based on magnetic properties of the workpiece to be analyzed, namely a functional correlation between its longitudinal stresses and magnetic properties. A stressfree state is determined based on a function that describes the correlation between a magnetic response signal, which is received in response to the magnetic input signal, and the longitudinal stress introduced into the workpiece.

The characteristic features of claims 3 and 4 concern an embodiment of the method. In this case, for example, it is possible to utilize the fact that the principal direction of an externally excited magnetic field and the principal direction of a magnetization of the workpiece induced thereby coincide when a stressfree state is reached, but otherwise differ from one another. In this embodiment, the evaluation of the method is dependent on the signal, which is received in the receiver coil and can be visually represented in a function describing this dependence, wherein the result of the method, namely the determination of a stressfree state, is derived from this function. The signal induced in the receiver coil is processed in accordance with a mathematical model and evaluated in a function. As an alternative to a receiver coil, a receiver may also be realized with other magnetic field sensors. For example, GMR sensors (giant magnetoresistive sensors), Hall effect sensors or AMR sensors (anisotropic magnetoresistive sensors), among other things, may be considered for this purpose.

The characteristic features of claims 5 and 6 concern another embodiment of the method. In this case, the transmitter and receiver coils are respectively incorporated into a magnetic circuit, one element of which consists of the representative volume of the workpiece.

The characteristic features of claim 7 concern an alternative approach, in which the aforementioned signal respectively consists of an ultrasonic signal or an ultrasonic signal sequence and a response signal in the form of an ultrasonic signal, which is dependent on the longitudinal stress, is decoupled from the representative volume, namely the test section, such that the method is in this case based on the determination of a function that describes the correlation between this signal and the respectively introduced longitudinal stress.

Comparable advantages in comparison with the initially described prior art are also attained with the above-described alternative solution.

According to the characteristic features of claim 8, element chains consisting of ultrasonic transmitters and ultrasonic receivers, which are arranged opposite of one another transverse to the longitudinal direction of the workpiece, may be considered for carrying out the method, wherein the section of the workpiece lying between these ultrasonic transmitters and ultrasonic receivers forms the representative volume in this case.

According to the characteristic features of claim 9, transverse waves are introduced into the representative volume, for example in the form of wave packets, in order to carry out the method. These transverse waves may practically be made available by diffracting and refracting sound waves, by means of mode conversion, by means of piezoelectric transducers or by means of systems according to the EMAT technology (electromagnetic acoustic transducer).

Actually, numerous parameters of the decoupled ultrasonic signal are influenced by the respective longitudinal stress such that it is possible to realize different approaches, which are based on different parameters. According to the characteristic features of claims 10 and 11, for example, the polarizing angles of ultrasonic transmitters and ultrasonic receivers relative to the longitudinal direction of the workpiece may be fixed or variable within defined angular ranges.

The magnetic variation of the inventive method is particularly suitable for ferromagnetic workpieces, namely profiled workpieces such as railway rails, metal sheets, pipes and wires, and generally for metallic workpieces with an extensive longitudinal structure produced, e.g., by means of cold rolling and for braided or twisted workpieces such as steel cables.

Furthermore, the ultrasonic variation of the method is also generally suitable for workpieces with a fibrous structure such as, e.g., wooden beams, composite materials, etc.

The invention is described in greater detail below with reference to the attached drawings. In these drawings:

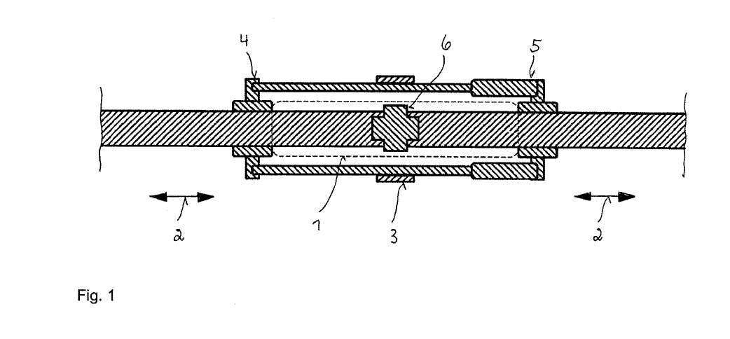

FIG. 1 shows a schematic representation of an inventive measuring arrangement that operates based on ultrasound;

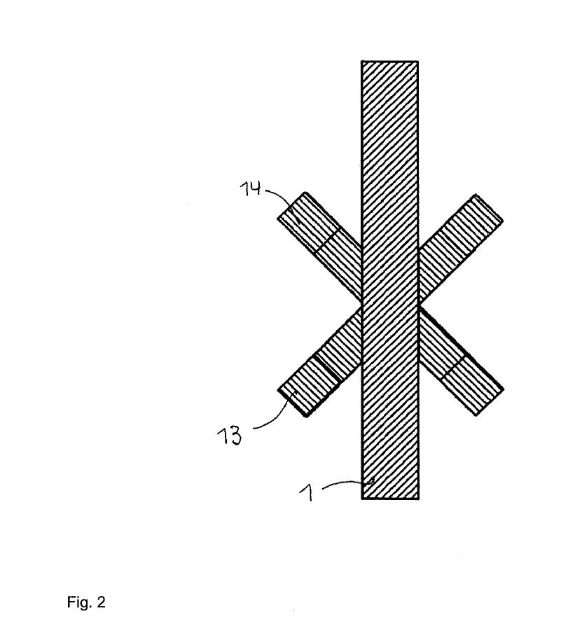

FIG. 2 shows a schematic representation of a magnetic sensor configuration;

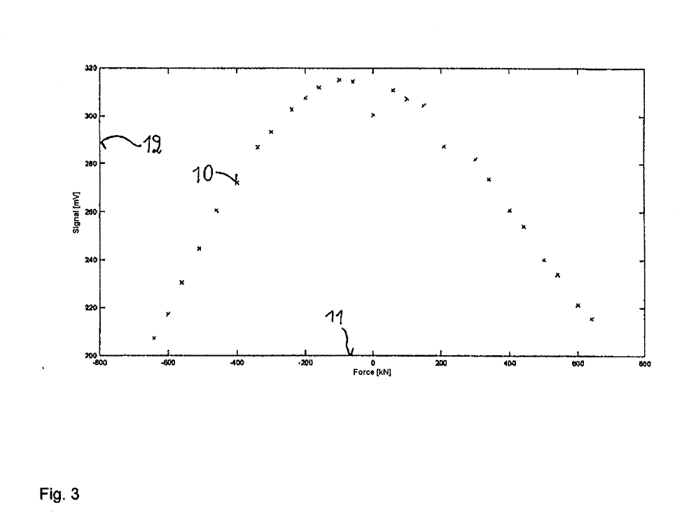

FIG. 3 shows a graphic representation for determining the stressfree state of the rail based on a transit time measurement with ultrasonic waves;

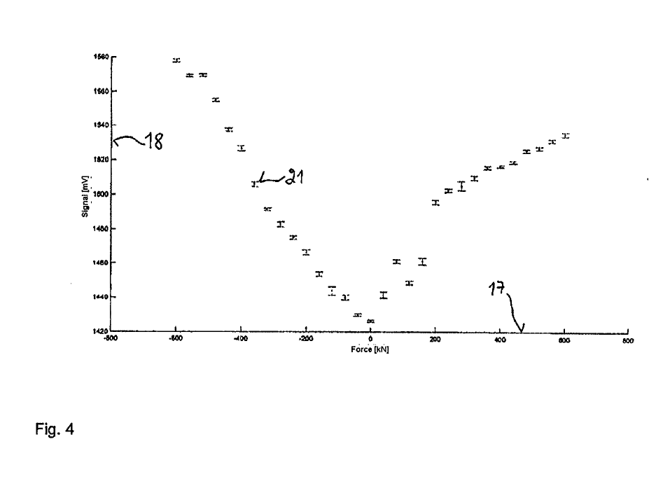

FIG. 4 shows a graphic representation for determining the stressfree state of the rail based on their magnetization;

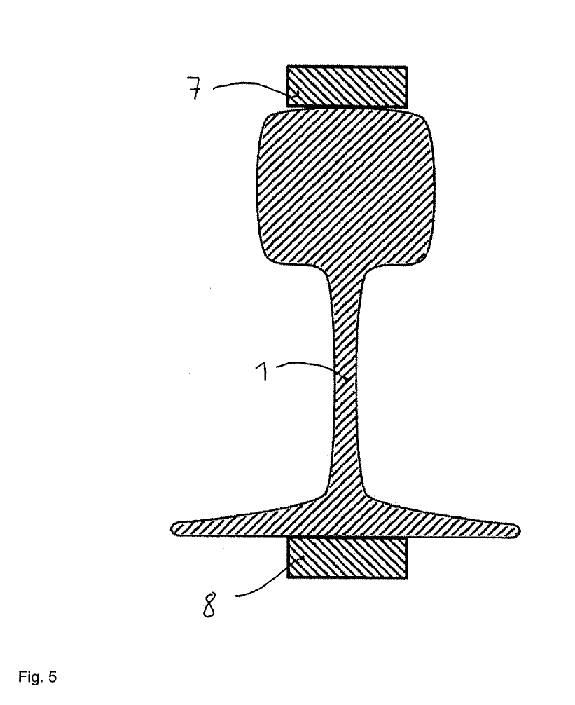

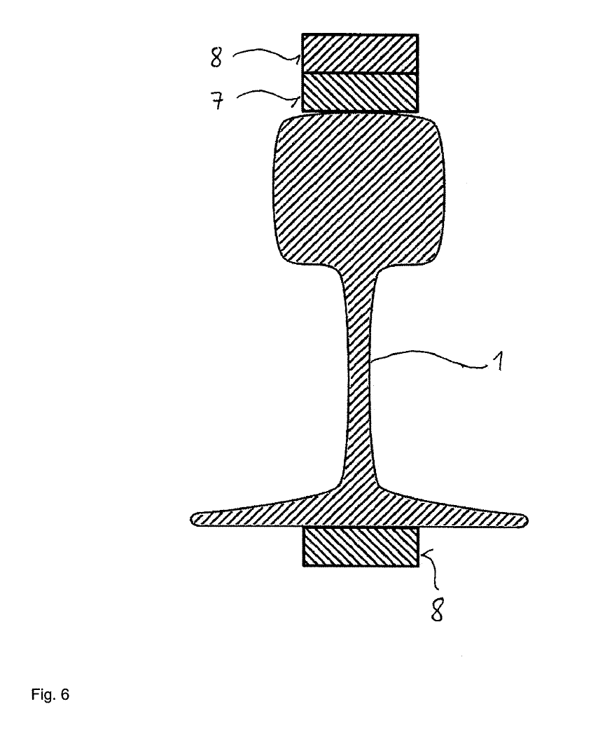

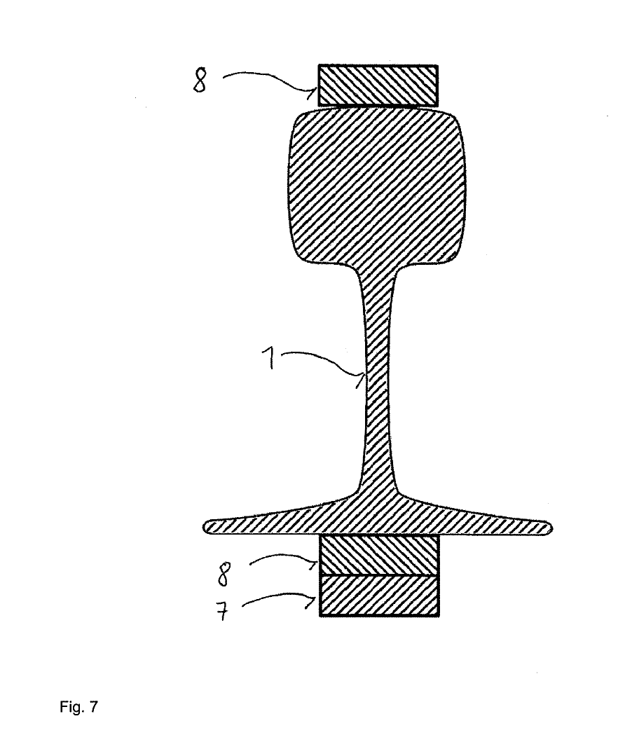

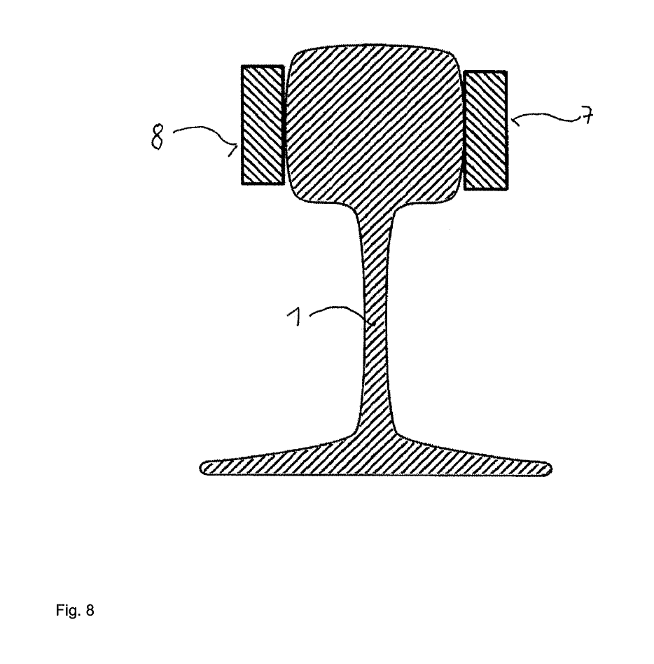

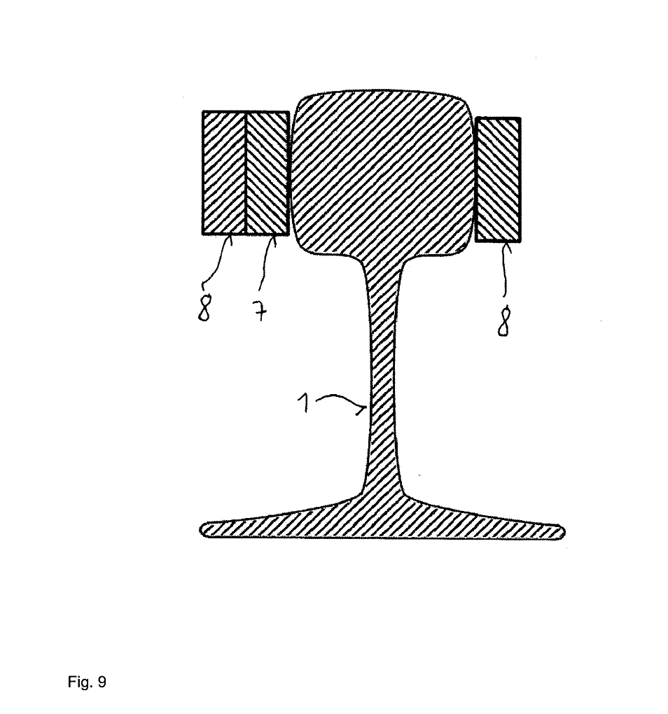

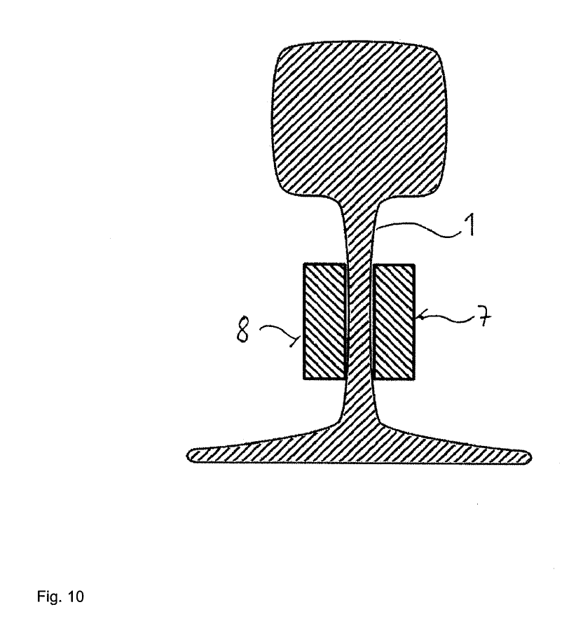

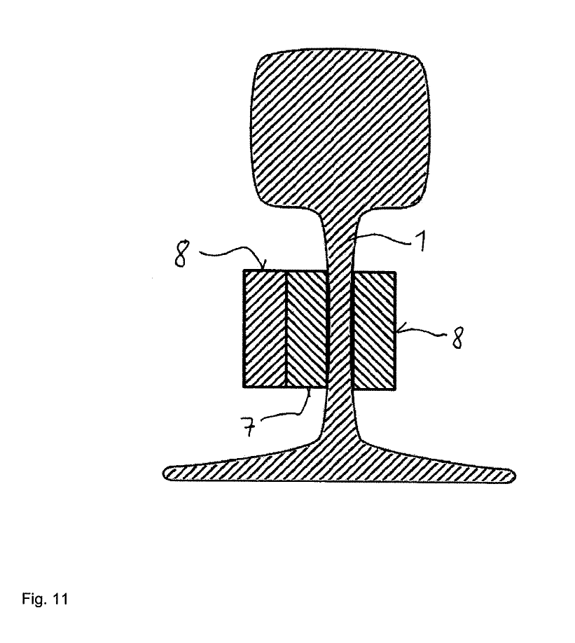

FIG. 5-FIG. 11 show alternative arrangements of transmitter and receiver modules for coupling a magnetic field into the rail profile to be analyzed and for determining a response signal; and

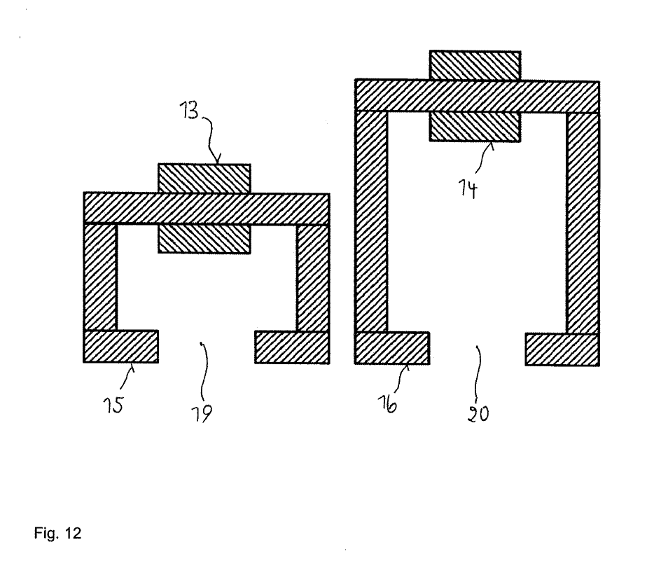

FIG. 12 shows isolated partial representations of the magnetic sensor configuration according to FIG. 2.

In FIG. 1, the reference symbol 1 identifies a rail section that should be analyzed with respect to longitudinal stresses, particularly a neutral temperature, by utilizing the inventive method.

A device intended and designed for introducing longitudinal stresses into this rail section 1 in the direction of the arrows 2 is not illustrated in this figure. However, devices of this type are generally known such that a more detailed description of their design is unnecessary. These longitudinal stresses are uniformly introduced into the rail section 1 on both sides.

The reference symbol 3 identifies a device for measuring the introduced external longitudinal stress, which is connected to the rail section 1 by means of clamping jaws 4, 5.

Two exemplary embodiments of sensor arrangements 6 for determining the stressfree state are described below, namely an embodiment that is based on alternating magnetic fields in accordance with claim 2 and an embodiment that is based on ultrasonic waves in accordance with claim 7.

The reference symbol 7 identifies an ultrasonic transmitter that emits transverse wave packets with a center frequency of 1 MHz to 10 MHz in a defined polarizing direction relative to the longitudinal axis of the rail section 1, wherein these transverse wave packets propagate within a representative volume of the rail material perpendicular to its surface and are ultimately detected by an ultrasonic receiver 8. The volume of the rail material, which is thusly penetrated by ultrasonic waves, is defined by the positioning of the ultrasonic transmitter 7 and the ultrasonic receiver 8 and located within the rail section 1.

A device for measuring the rail temperature is not illustrated in this figure. However, such a measurement is only required once.

FIGS. 2-11 show potential positions of the ultrasonic transmitter 7 and the ultrasonic receiver 8 relative to a cross-sectional profile 9 of the rail section 1. In this respect, it is essential that the ultrasonic transmitter 7 and the ultrasonic receiver 8 are arranged in an opposing fashion. The receivers could basically also be provided on both sides of the representative volume. This would make it possible to also receive reflected signal components. Furthermore, the two receivers could also be designed for receiving differently polarized transverse waves.

According to the basic principle of the measurement, the signal detected by the ultrasonic receiver 8 is dependent on the angles between the longitudinal rail axis and the polarizing directions of the transmitter and the receiver, as well as on a longitudinal rail stress, but not dependent on a calibration and on material parameters. A non-linear correlation exists between the angle formed by the longitudinal rail axis and the polarizing directions and the amount of longitudinal stress in the rail section. In addition, the measurements are not influenced by an internal stress component due to the selection of a representative volume to be penetrated by ultrasonic waves, wherein the time period required for the measurement is limited to a few minutes depending on the measured stress range and the device used for introducing mechanical stresses into the rail section.

The measurements can be carried out with fixed angles between the polarizing directions and the longitudinal rail axis. However, measurements with fixed angles, for example, of 0°, 45° or 90° or a pass through an angular range, for example, from 0° to 90° would also be conceivable.

FIG. 3 shows the respective determination of the neutral temperature or the stressfree state based on the analytical determination of the maximum of the function 10 illustrated in this figure, wherein the force introduced into the rail section is plotted on the abscissa 11. A parameter that is dependent on longitudinal stresses such as, e.g., a transit time shift between the transmitted and the received signal is plotted on the ordinate 12, but it would also be possible to use other parameter differences between these two signals. The maximum of the function 10 indicates the position of the stressfree state and therefore the neutral temperature.

A magnetic-inductive arrangement may also be used instead of an ultrasonic sensor 6. This measuring arrangement is based on the fact that nearly all magnetic properties of ferromagnetic materials are influenced by external mechanical stress. In this respect, we refer to FIGS. 2 and 12, in which functional elements corresponding to those in FIGS. 1 and 3-11 are identified by the same reference symbols.

The reference symbol 13 identifies a transmitter coil, the axis of which extends at an angle of 45° to the longitudinal rail axis of the rail section 1. This transmitter coil subjects the rail section 1 to a alternating magnetic field, by means of which a magnetization is induced in said rail section in response to this magnetic excitation, wherein the direction and intensity of this magnetization are influenced by the externally excited magnetic field, as well as by the mechanical stress, particularly the longitudinal stress, in the rail section.

The reference symbol 14 identifies a receiver coil, the axis of which extends at an angle of 90° to the axis of the transmitter coil 13.

The transmitter coil 13 and the receiver coil 14 are respectively incorporated into a magnetic circuit, which also includes the rail head of the cross-sectional profile of the rail section 1, such that a signal received by the receiver coil 14 is influenced by the rail head.

FIG. 12 shows two magnetic circuits 15, 16 that act as carriers of the transmitter coil 13 and the receiver coil 14 and respectively feature a gap 19, 20, which is designed for accommodating the rail head of the rail section 1 in order to complete these circuits. In the inserted state, the datum planes of the magnetic circuits extend at an angle of 45° to the longitudinal rail axis and at an angle of 90° to one another.

During the operation of this magnetic-inductive measuring arrangement, the signal decoupled by the receiver coil is evaluated, particularly with respect to deviations between the magnetization and the external magnetic field. The rail section is in the stressfree state when the magnetization and the external magnetic field coincide.

The evaluation of the signal received by means of the receiver coil 14 may take place in accordance with a mathematical model, the evaluation result of which is graphically illustrated in FIG. 3. The forces introduced into the rail section 1 are plotted on the abscissa 17 whereas the response signal of the receiver coil 14 is plotted on the ordinate 18. The sequence of determined measuring points describes a function 21, the minimum of which describes the position of the stressfree state and therefore the neutral temperature.

This variation of the method can also be carried out within a few minutes, wherein neither a calibration nor information on material parameters of the rail section 1 is required.

### LIST OF REFERENCE SYMBOLS

1 Rail section

2 Arrows

3 Device

4 Clamping jaw

5 Clamping jaw

6 Sensor arrangement

7 Ultrasonic transmitter

8 Ultrasonic receiver

9 Cross-sectional profile

10 Function

11 Abscissa

12 Ordinate

13 Transmitter coil

14 Receiver coil

15 Magnetic circuit

16 Magnetic circuit

17 Abscissa

18 Ordinate

19 Gap

20 Gap

21 Function

1. A method for respectively determining the neutral temperature or the stressfree state of an elongate workpiece, wherein a test section of said workpiece is subjected to longitudinal stress in a defined fashion, and wherein the state of stress in the test section is determined and used as the basis for determining the stressfree state, characterized in that a signal, which is influenced by the value of the longitudinal stress, or a sequence of these signals is coupled into a representative volume of the workpiece cross section, in that longitudinal stresses are introduced into the test section of the workpiece, in that a signal decoupled from the representative volume is evaluated, in that a function describing the functional dependence of a parameter of the decoupled signal on the respective longitudinal stress is determined, and in that the stressfree state is determined based on the course of this function with consideration of the temperature during the measurement.

2. The method according to claim 1, characterized in that a magnetic signal or a sequence of magnetic signals is coupled into the representative volume of the workpiece, in that the magnetic signal decoupled from the representative volume is evaluated, in that a function (21) describing the functional dependence of a parameter of the decoupled magnetic signal on the respective longitudinal stress is determined, and in that the stressfree state is determined based on the course of this function (21).

3. The method according to claim 2, characterized in that the evaluation is carried out based on the determination of the deviation between an externally excited magnetic field and a magnetization in the representative volume induced thereby.

4. The method according to claim 2, characterized in that at least one transmitter coil (13) and one receiver coil (14) are used for the magnetic signal and assigned to the representative volume.

5. The method according to claim 4, characterized in that the transmitter coil (13) and the receiver coil (14) are arranged in such a way that their axes extend at an angle of 90° to one another and that angles of 45° to the longitudinal axis of the workpiece.

6. The method according to claim 5, characterized in that the transmitter coil (13) and the receiver coil (14) are respectively incorporated into magnetic circuits (15, 16), in which one element is formed by part of the workpiece.

7. The method according to claim 1, characterized in that an ultrasonic signal or a sequence of ultrasonic signals is coupled into the representative volume of the workpiece, in that an ultrasonic signal decoupled from the representative volume is evaluated, in that a function (10) describing the functional dependence of a parameter of the decoupled ultrasonic signal on the respective longitudinal stress is determined, and that the stressfree state is determined based on the course of this function (10).

8. The method according to claim 1, characterized in that a workpiece section located between a transmitter (7) and a receiver (8), which is arranged opposite of said transmitter transverse to a longitudinal workpiece direction, is used as representative volume.

9. The method according to claim 1, characterized in that ultrasonic signals in the form of transverse waves are used in the representative volume, and in that the valuation of a decoupled signal is carried out with consideration of the polarizing angles of the transmitter (7) and the receiver (8) relative to a longitudinal axis of the workpiece.

10. The method according to claim 9, characterized in that the determination of the neutral temperature is carried out with fixed polarizing angles.

11. The method according to claim 9, characterized in that the determination of the neutral temperature is carried out with polarizing angles, which can be varied within an angular range between 0° and 90°.

12. The method according to claim 3 characterized in that at least one transmitter coil (13) and one receiver coil (14) are used for the magnetic signal and assigned to the representative volume.

13. The method according to claim 12, characterized in that the transmitter coil (13) and the receiver coil (14) are arranged in such a way that their axes extend at an angle of 90° to one another and that angles of 45° to the longitudinal axis of the workpiece.

14. The method according to claim 12, characterized in that the transmitter coil (13) and the receiver coil (14) are respectively incorporated into magnetic circuits (15, 16), in which one element is formed by part of the workpiece.

15. The method according to claim 13, characterized in that the transmitter coil (13) and the receiver coil (14) are respectively incorporated into magnetic circuits (15, 16), in which one element is formed by part of the workpiece.

16. The method according to claim 7 characterized in that a workpiece section located between a transmitter (7) and a receiver (8), which is arranged opposite of said transmitter transverse to a longitudinal workpiece direction, is used as representative volume.

17. The method according to claim 7 characterized in that ultrasonic signals in the form of transverse waves are used in the representative volume, and in that the valuation of a decoupled signal is carried out with consideration of the polarizing angles of the transmitter (7) and the receiver (8) relative to a longitudinal axis of the workpiece.

18. The method according to claim 8 characterized in that ultrasonic signals in the form of transverse waves are used in the representative volume, and in that the valuation of a decoupled signal is carried out with consideration of the polarizing angles of the transmitter (7) and the receiver (8) relative to a longitudinal axis of the workpiece.

19. The method according to claim 17, characterized in that the determination of the neutral temperature is carried out with fixed polarizing angles.

20. The method according to claim 18, characterized in that the determination of the neutral temperature is carried out with fixed polarizing angles.
